(19) United States
(12) Patent Application Publication
(10) Pub. No.: US 2014/0091768 A1
(43) Pub. Date: Apr. 3, 2014

(54) STORAGE DEVICE FOR STORING ELECTRICAL ENERGY AND METHOD FOR OPERATING A STORAGE DEVICE

(71) Applicants: Alexander Osswald, Stuttgart (DE); Rainer Glauning, Leinfelden-Enchterdingen (DE); Thomas Heinrich, Nelimersbach (DE)

(72) Inventors: Alexander Osswald, Stuttgart (DE); Rainer Glauning, Leinfelden-Enchterdingen (DE); Thomas Heinrich, Nelimersbach (DE)

(21) Appl. No.: 14/004,524

(22) PCT Filed: Jan. 12, 2012
(86) PCT No.: PCT/EP12/50437

§ 371 Date: Dec. 16, 2013

(30) Foreign Application Priority Data
Mar. 11, 2011 (DE) 10 2011 005 425.1

(51) Int. Cl. H02J 7/00

(52) U.S. Cl. CPC H02J 7/0031
USPC 320/134

(57) ABSTRACT

The invention relates to a storage device (101) for storing electrical energy, having a storage cell (103) that is chargeable using an electric charging current, having a charging circuit (105) connected to the storage cell (103) for charging the storage cell (103), having a discharging circuit (107) connected to the storage cell (103) for discharging the storage cell (103) and a monitoring device (109) for monitoring a physical variable in the storage cell (103), a switching element (111) controllable by the monitoring device (109) for interrupting the charging circuit (105) being formed as a function of the monitored physical variable. The invention also relates to a method for operating a storage device (101) for storing electrical energy.

### FIELD OF THE INVENTION

The present invention relates to a storage device for storing electrical energy. The invention also relates to a method for operating a storage device for storing electrical energy.

### BACKGROUND INFORMATION

In order to avoid damage to storage cells of a battery, the storage cell must not be overloaded. It is known that a charging device breaks off a charging process in time, i.e. before an overloading of the storage cell, and that it switches off a corresponding charging current. The disadvantage of this is particularly that, in case of a defect in the charging device, under certain circumstances, it does not switch off the charging current in time, so that the storage cell is able to be overloaded, which may lead to damage to the storage cell.

### SUMMARY

An object on which the present invention is based may therefore be seen as stating a storage device for storing electrical energy, any overloading being effectively prevented even in the case of a defective charging device.

The object on which the present invention is based may therefore also be seen as stating a method for operating a storage device for storing electrical energy.

According to one aspect, a storage device is provided for storing electrical energy. The storage device is preferably developed as a battery. The battery may also be denoted as a battery pack. For instance, the storage device may be developed as a lead battery, a lithium ion battery, a lithium polymer battery, a lithium iron phosphate battery, a lithium titanate battery, a sodium nickel chloride battery, a sodium sulfur battery, a nickel iron battery, a nickel cadmium battery, a nickel metal hydride battery, a nickel hydrogen battery, a nickel zinc battery, or as a tin sulfur lithium battery.

The storage device includes a storage cell which is able to be charged using an electric charging current. The storage cell may be a galvanic cell, for example. In connection with batteries, such a storage cell may also particularly be denoted as a secondary cell. A charging circuit is connected to the storage cell, via which the storage cell is able to be charged. This means that the electric charging current for charging the storage cell flows via the charging circuit. A charging circuit is also connected to the storage cell, via which the storage cell is able to be discharged. This therefore means that an electric discharge current is able to flow via the discharge current circuit. This electric discharge current may particularly be provided to an electrical consumer connected to the storage device.

The storage device further includes a monitoring device which monitors a physical variable in the storage cell. The physical variable may, for instance, be a temperature in the storage cell and/or an electric voltage in the storage cell. Such a temperature may also particularly be designated as a storage cell temperature. Such an electric voltage may also particularly be designated as a storage cell voltage.

In addition, the storage device includes a switching element which is controllable by the monitoring device. This switching element is able to interrupt the charging circuit, a control of the switching element and thus also an interruption of the charging circuit being a function of the monitored physical variable. Thus, this control takes place particularly as a function of the monitored variable. This means, for example, that during a rise in the storage cell temperature and/or during a rise in the storage cell voltage above a predetermined voltage value or temperature value, the monitoring device sends a control signal to the switching element, so that it interrupts the charging current or rather the charging circuit.

A switching element within the meaning of the present invention has two switching states in particular: An open switching state, in which the charging circuit is interrupted, so that no charging current for charging the storage cell is able to flow, and a closed charging state in which the charging circuit is closed so that an electric charging current for charging the storage cell is able to flow. When the switching element is in the open switching state, the switching element may also be designated as an open switching element. When the switching element is in the closed switching state, the switching element may also be designated as a closed switching element.

According to one further aspect, a method for operating the storage device according to the present invention is provided, the storage cell being charged using an electric charging current, and a physical variable in the storage cell being monitored. The charging circuit is interrupted as a function of the monitored variable.

That is, the present invention includes the idea, during the charging process of the storage cell, of monitoring a physical variable, particularly a temperature and/or a voltage in the storage cell, and, as a function of the monitored physical variable, to interrupt the charging process by interrupting the charging circuit. Since the monitored physical variable is particularly a function of a charging state of the storage cell, an overcharging of the storage cell, and, perhaps occurring with that, damage to the storage cell may effectively be avoided. For instance, the charging circuit is interrupted if the physical variable is greater than a predetermined value.

The fact that the storage device has both a charging circuit, for charging the storage cell, and a discharging circuit, for discharging the storage cell, means in particular that a discharging current flows via a different circuit than a charging current. This being the case, the two current circuits have current paths that are separate from each other. However, it may also be provided, in this instance, that the two current circuits have common current paths. For example, the two current circuits may have a common ground connection. The charging circuit preferably includes a charging contact for contacting or attaching a charging unit. The discharging circuit particularly includes a discharging contact for contacting or attaching an electric consumer. The charging contact and the discharging contact are particularly developed separately from each other.

In one different specific embodiment, a plurality of storage cells is formed. In order to increase the voltage provided by the storage cells, the storage cells may particularly be connected in series, or, in order to increase the overall capacitance of the storage cells, they may be connected in parallel. Preferably, it may also be provided that a few storage cells are connected in parallel and a few storage cells are connected in series, the storage cells connected in parallel, in turn, being connected in parallel or in series with respect to the ones connected in series. In particular, in the case of a plurality of storage cells, it is sufficient that a physical variable in a storage cell is at greater than a predetermined value in order to break off the charging process.

In another specific embodiment, the switching element is designed as a reversible switching element. In this case, reversible means in particular that the switching element is switched back and forth between the open switching state and the closed switching state. Consequently, in an advantageous manner, the storage cell may thus continue to be charged or may newly be charged if the physical variable corresponds again to an admissible value, since the reversible switching element is able to close the charging circuit again.

According to another specific embodiment, the switching element is a transistor, especially a field effect transistor (FET), preferably a normally on field effect transistor or a relay.

In particular, the switching element is closed in normal operation, so that the charging circuit is a closed charging circuit, so that the storage cell is able to be charged using the charging current. A normal operation is particularly characterized in that the physical variable is less than a predetermined value. The switching element opens only in the fault case and interrupts the charging circuit, so that a charging process of the storage cell is broken off. A fault case is particularly characterized in that the physical variable is greater than a predetermined value. The charging circuit is interrupted, for example, if the storage cell voltage and/or the storage cell temperature are greater than an admissible voltage value or temperature value respectively. Especially when using a field effect transistor, it is actuated using the monitoring device in normal operation and blocked in the fault case. An usually on field effect transistor is preferably used as a switching element which is particularly only blocked in the fault case.

According to one other specific embodiment, the switching element is connected serially, or rather in series, in the charging circuit, and in this instance, particularly in series with the storage cell. Since in the charging circuit, charging currents are clearly smaller than discharging currents in the discharging circuit, the switching element has to be designed only for the lowest charging current. By contrast to this, in a storage device having a common charging/discharging circuit, such a switching element would also have to be designed for the clearly higher discharging current. In this case, the present invention thus particularly makes possible in an advantageous manner the use of a technically simpler, less complex and less costly switching element.

In yet another specific embodiment, the charging circuit is closed again if the monitored variable is less than a predetermined value. Thus if, in particular, a storage cell voltage and/or a storage cell temperature again have admissible values, the storage cell may be charged again. In particular, the charging circuit is first closed again when the storage cell has been discharged via the discharging circuit.

### BRIEF DESCRIPTION OF THE DRAWINGS

FIG. 1 shows a storage device for storing electrical energy.

FIG. 2 shows an additional storage device for storing electrical energy.

FIG. 3 shows a flow chart of a method for operating a storage device for storing electrical energy.

### DETAILED DESCRIPTION

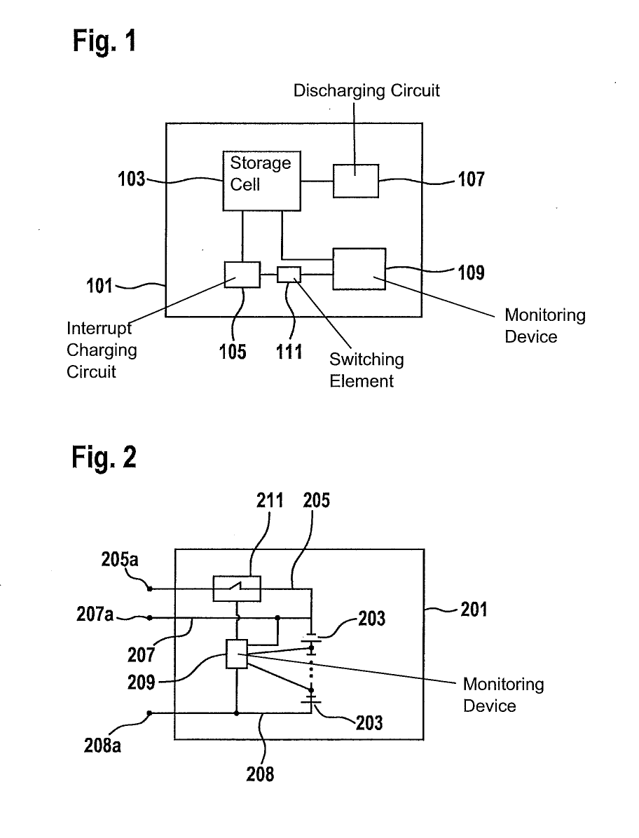

FIG. 1 shows a storage device 101 for storing electrical energy. Storage device 101 may be developed as a battery, for example. Such a battery may also be denoted as a battery pack. Storage device 101 includes a storage cell 103, which is able to be charged using an electric charging current. For this purpose, storage cell 103 is connected to a charging circuit 105. To discharge storage cell 103, a discharging circuit 107 is formed, which is connected to storage cell 103. This being the case, a corresponding discharging circuit may flow or flow away from storage cell 103 via discharging circuit 107.

Storage device 101 further includes a monitoring device 109 which monitors a physical variable in storage cell 103. In particular, monitoring device 109 monitors the physical variable in storage cell 103 during the charging process. The physical variable may particularly be a storage cell temperature and/or a storage cell voltage.

Moreover, a switching element 111 is provided, which is able to interrupt charging circuit 105. In this case, switching element 111 is controlled appropriately, this control being a function of the monitored physical variable. Thus, for example, if the temperature in the storage cell rises above a predetermined value or an electric voltage in the storage cell rises above a predetermined voltage value, this is detected using the monitored variable, and it then controls switching element 111 correspondingly, so that switching element 111 interrupts charging circuit 105. Consequently, the overcharging of the storage cell is effectively avoided, in an advantageous manner. This particularly happens independently of a charging unit, not shown here, so that even if the charging unit is defective, and it is no longer able to switch off a charging current independently, overcharging of the storage cell, and with that, possible damage is able to be effectively avoided. Furthermore, a charging unit does not have to have any corresponding charging current switching-off automatic system at all, since the automatic switching off is carried out in the storage device itself. Consequently, the charging unit is able to be produced in a less costly manner.

In one specific embodiment not shown, switching element 111 is developed as a reversible switching element. According to another specific embodiment not shown, the switching element may be a transistor, especially a field effect transistor, preferably a normally on field effect transistor or a relay.

FIG. 2 shows an additional storage device 201 for storing electrical energy. Storage device 201 includes a plurality of storage cells 203, which are connected in series. To charge storage cells 203, a charging circuit 205 having a charging contact 205a is formed for contacting a charging unit. To discharge storage cells 203, a discharging circuit 207 is formed having a discharging contact 207a, discharging contact 207a being particularly able to be contacted to an electrical consumer.

Storage device 201 further includes a monitoring device 209 which monitors a physical variable such as a storage cell voltage and/or a storage cell temperature in the storage cells 203. Monitoring device 209 controls a switching element 211, which is connected serially in the charging circuit between the charging contact 205a and the storage cells 203. This switching element 111 is preferably designed as a transistor, a field effect transistor, especially as a normally on field effect transistor, or as a relay, and is thus advantageously able to interrupt charging circuit 205, so that no more charging current is able to flow to storage cells 203. In particular, switching element 211 is formed as a reversible switching element, so that switching element 211 is able to close charging circuit 205 again, so that storage cells 203 are able to be charged again, or rather charged further. In particular, switching element 211 is closed again if the physical variable corresponds again to an admissible value.

Charging circuit 205 and discharging circuit 207 do have two separate contacts, charging contact 205a and discharging contact 207a, but they have a common current path 208 having a common ground contact 208a.

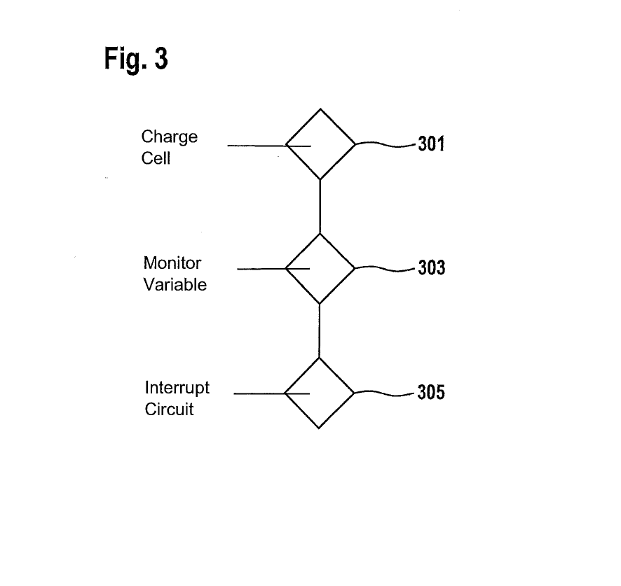

FIG. 3 shows a flow chart of a method for operating a storage device for storing electrical energy. In a step 301, the storage cell is charged, using an electric charging current, in a step 303 a physical variable being monitored in the storage cell. This monitoring particularly takes place simultaneously with the charging of the storage cell. In a step 305, the charging circuit is interrupted as a function of the monitored variable. If, for example, there is present a storage cell temperature below a predetermined temperature, the charging circuit is not interrupted. The charging circuit is interrupted only if the temperature rises above the predetermined temperature value. The statements just made apply analogously also to a storage cell voltage. In one exemplary embodiment not shown, it may be provided that the charging circuit is closed again if the monitored variable is again less than the predetermined value.

In summary, using the present invention, a redundant design of a charging unit is no longer required. In the case of a defective charging unit, the storage cell is not damaged or even destroyed, since, according to the present invention, an interruption of the charging circuit is carried out independently of the charging unit. Because charging currents are usually less than discharging currents, the switching element has to be designed advantageously only for the smaller charging currents.

1.-6. (canceled)

7. A storage device for storing electrical energy, comprising:
a storage cell that is chargeable using an electric charging current;
a charging circuit connected to the storage cell for charging the storage cell;
a discharging circuit connected to the storage cell for discharging the storage cell;
a monitoring device for monitoring a physical variable in the storage cell; and
a switching element controllable by the monitoring device and for interrupting the charging circuit, the switching element being formed as a function of the monitored physical variable.

8. The storage device as recited in claim 7, wherein the switching element is a reversible switching element.

9. The storage device as recited in claim 7, wherein the switching element includes one of a transistor, a field effect transistor, and a relay.

10. The storage device as recited in claim 7, wherein the switching element is connected serially in the charging circuit.

11. A method for operating a storage device for storing electrical energy that includes a storage cell that is chargeable using an electric charging current, a charging circuit connected to the storage cell for charging the storage cell, a discharging circuit connected to the storage cell for discharging the storage cell, a monitoring device for monitoring a physical variable in the storage cell, and a switching element controllable by the monitoring device and for interrupting the charging circuit, the switching element being formed as a function of the monitored physical variable, the method comprising:
charging the storage cell using the electric charging current;
monitoring the physical variable in the storage cell; and
interrupting the charging circuit as a function of the monitored variable.

12. The method as recited in claim 11, wherein the charging circuit is closed again if the monitored variable is less than a predetermined value.
